(19) United States
(12) Patent Application Publication
(10) Pub. No.: US 2008/0022536 A1
(43) Pub. Date: Jan. 31, 2008

(54) Pattern cutter

(76) Inventor: Walter W. Hsu, Tou-Liu (TW)

Correspondence Address: SOFER & HAROUN LLP., 317 MADISON AVENUE, SUITE 910, NEW YORK, NY, 10017, US

(21) Appl. No.: 11/494,283

(22) Filed: Jul. 27, 2006

(51) Int. Cl. B26D 7/00

(52) U.S. Cl. 30/310; 83/745

(57) ABSTRACT

A cutter for cutting a pattern in a substrate, said cutter having a base and guide pins disposed on the bottom of the base. The guide pins are placed in a groove on a template. A longitudinally adjustable member supports a blade unit for cutting the pattern into the substrate, where the adjustable member is configured to be slidably positioned within a center track opening region movable towards and away from the guide pins.

### FIELD OF THE INVENTION

The present invention is directed towards a pattern cutter. More particularly, the present invention is directed to an improved pattern cutter for cutting patterns such as circles or other designs, into a substrate.

### BACKGROUND OF THE INVENTION

A compass is the most common tool used by people to draw and cut circles into a substrate, but there have been different auxiliary instruments developed to facilitate the drawing or cutting of circles of various diameters and variations such as a standard circle board on which circles of various sizes are orderly distributed with their diameters marked beside each hole so as to permit people to make circle cuttings with ease. However, devices such as these are generally restricted to cutting circle patterns in fairly standard, uniform dimensions.

One example of such a device is found in U.S. Pat. No. 6,286,216, issued to Braun that provides a tool for making circular cuts. The tool comprises a relatively stationary base hub with a shaft extending upwardly therefrom, and a hand pressure knob mounted on the shaft opposite the base hub. A rotary disc with a radial channel having a cutting arm and rotary cutting blade therein, is sandwiched between the base hub and pressure knob. The tool is placed upon the sheet material and pressure is applied to the pressure knob, with the cutting arm and rotary disc being rotated about the hub and knob to drive the cutting blade in a circular path about the hub.

Another example of such a cutting tool is found in U.S. Pat. No. 6,374,503 issued to Carlson et al. that provides for an oval cutter. The oval cutter comprises a clicker plate for adjusting the ellipticity of ovals in a single movement. The clicker plate can be rotated about a base using a knob mounted on the clicker plate.

Another means for cutting circles into a substrate utilizes a template and associated cutting tool configured to be moved about the template in a circular pattern. However, these devices also suffer from several drawbacks as well. For example, the prior art circle cutting devices, although capable of cutting non-uniform circular patterns, typically are provided with a cutting blade that is fixed in relation to its template guides. By fixing the distance between the guides and the cutting blade, the cutting device is limited in terms of the number or variations in patterns that can be cut by a single cutting tool.

One such example of this type of circle cutter is found in U.S. Pat. No. 6,216,577 that discloses a guided cutting system. The cutting end includes a pair of guide pegs and a cutting blade wherein the guide pegs are adapted to be received within a peripheral groove formed on a template. In fact in order to get different spacings between the cutting blade and guide pegs, there are two separate blade cartridges required for operation.

Another example of this type of device is found in U.S. Patent Publication No. 2002/0134213 that discloses a substrate cutting system. The cutter and the cutter guide enable the substrate cutting operation by moving the cutter with guidable and guiding surfaces cooperating to guide the cutter so that the cutting edge of the blade cuts the selected substrate along a cutting path generally similar to the guiding surface to cut the substrate portion.

In both cases, the use of a guide means to guide a cutter around a template is restricted in that the distance between the guide means and the cutting blade is fixed, thus limiting the versatility of the cutter and of the types of patterns that can be used on the template.

Additionally, another drawback common amongst the prior art cutting devices for use on templates, is that their rotation about the template is often cumbersome and difficult because of the interaction between the guides and the track. Because the height of the device from the template provides for a high center of gravity, the movement of the cutting tool around the template is often prone to jerky or otherwise unstable movements during circle cutting.

As such, there exists a need to provide a circle pattern cutting device that is capable of cutting numerous different circle patterns from a single template without using a separate cutting tool for each new pattern. In particular there exists a need to provide a circle pattern cutting device for use with a template where the cutting member is not fixed in relation to the guide means. Likewise, there exists a need to provide a cutting device for use in conjunction with a template that does not suffer from the same unstable movements about the template as is the case with the prior art.

### SUMMARY OF THE INVENTION

The present invention looks to overcome the drawbacks associated with the prior art by providing a circle pattern cutting device having a cutting tool and an accompanying template, such that the cutting tool is configured to be guided around the template so as to smoothly cut any number of varying circular patterns into the desired substrate.

To this end, the present invention is directed to a cutter for cutting a pattern in a substrate, said cutter having a base and guide pins disposed on the bottom of the base. The guide pins are placed in a groove on a template. A longitudinally adjustable member supports a blade unit for cutting the pattern into the substrate, where the adjustable member is configured to be slidably positioned within a center track opening region movable towards and away from the guide pins.

### BRIEF DESCRIPTION OF THE FIGURES

FIG. 1 illustrates a perspective view of a cutter, in accordance with one embodiment of the present invention;

FIG. 2 is a bottom view of the cutter from FIG. 1, in accordance with one embodiment of the present invention;

FIG. 3 is an expanded view of the cutter from FIG. 1, in accordance with one embodiment of the present invention;

FIG. 4 illustrates a track for the cutter of FIG. 1, in accordance with one embodiment of the present invention;

FIG. 5 illustrates a center insert for the track from FIG. 4, in accordance with one embodiment of the present invention;

FIG. 6 illustrates alternate track designs, in accordance with one embodiment of the present invention;

FIG. 7 illustrates the track from FIG. 4 on top of a substrate, in accordance with one embodiment of the present invention;

FIG. 8 illustrates the cutter of FIG. 1, placed on the track as in FIG. 7, in accordance with one embodiment of the present invention; and

FIG. 9 illustrates the substrate from FIG. 7 with a design cut out from it, in accordance with one embodiment of the present invention.

### DETAILED DESCRIPTION

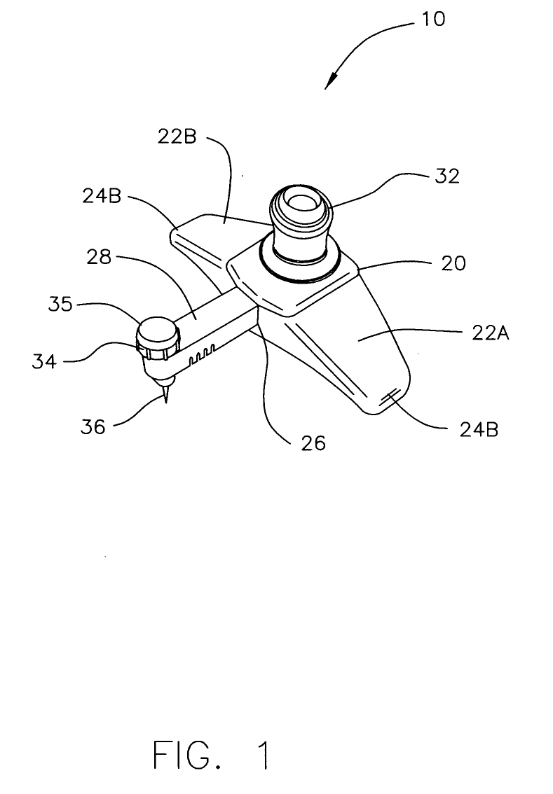

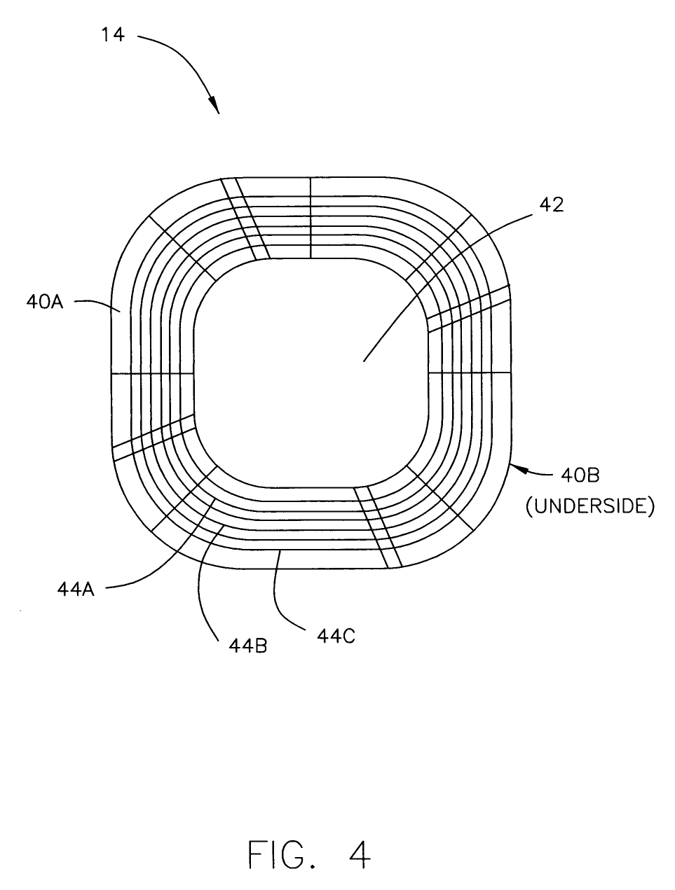

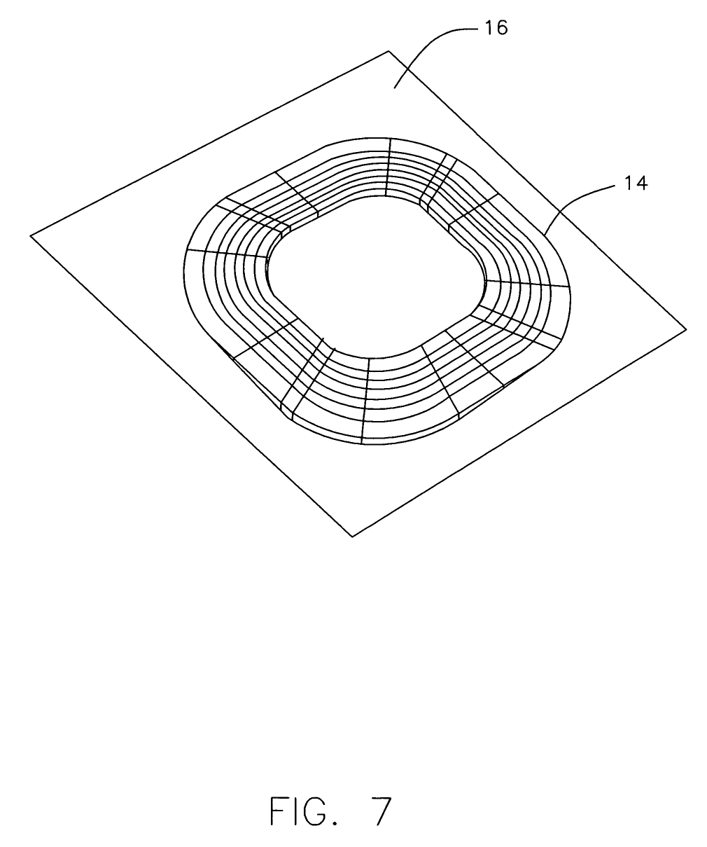

The present invention as illustrated in FIG. 1 is directed to a cutter 10 configured to be placed on a track template 14 shown in FIG. 4. Template 14 is in turn placed onto the desired substrate 16 as shown in FIG. 7 where cutter 10 is moved around template 14, such that cutter 10 cuts the desired circle pattern into substrate 16.

In one embodiment of the present invention, as illustrated in FIGS. 1 through 3, cutter 10 is comprised of a base portion 20 having first and second wing shaped supports 22a and 22b. First and second wing shaped supports 22a and 22b extend substantially perpendicularly away from base portion 20, configured to extending parallel to and flush against an upper surface 40a of template 14 as discussed below. (See FIG. 7) First and second wing shaped supports 22a and 22b may maintain a concave curvature similar to the general shape of template 14, such that the supports are disposed above template 14 as cutter 10 is moved, but the invention is not limited in this respect. During operation, a user may apply downward pressure on the first second pressure points 24a and 24b, located at the ends of first and second wing shaped supports 22a and 22b respectively, distal to base portion 20, so as to further stabilize the movement of cutter 10 on template 14.

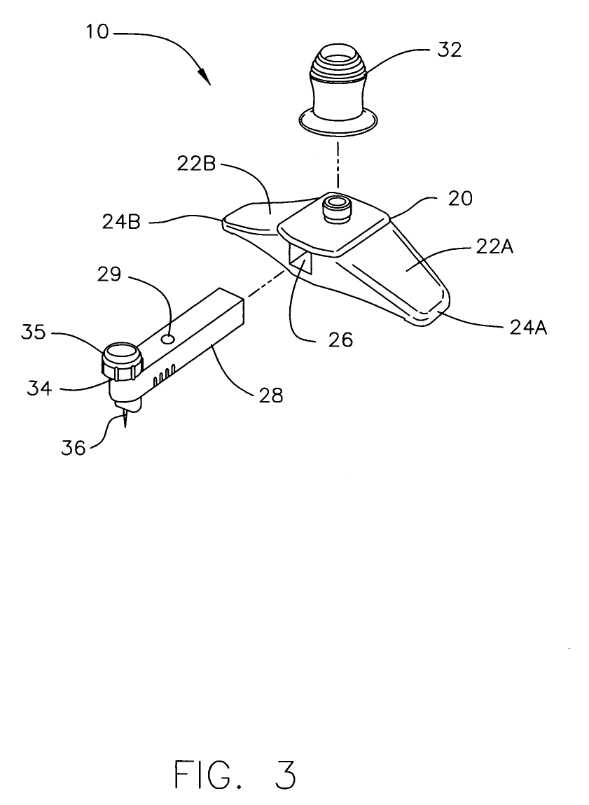

As illustrated in FIGS. 1 and 3, base portion 20 further maintains a center track opening 26 configured to support an adjustable member 28. Adjustable member 28 is slidably disposed within center track opening region 26 of base portion 20. Adjustable member 28 further maintains a spring biased member 29 that is partially exposed above the upper surface of member 28. Spring biased member 29 is preferably a ball bearing, however, any similar small shaped object may be used in the same fashion. Opening region 26 of base 20 maintains a corresponding series of ball joint openings 27 (internal, not shown). When adjustable member 28 is inserted into opening 26, spring biased member 29 is temporarily displaced downward until member 28 is inserted to a depth that member 29 may again bias outwards into one of openings 27. Once inside an opening 27, member 29 holds adjustable member 28 so that it remains at a constant on template 14 depth during the cutting process.

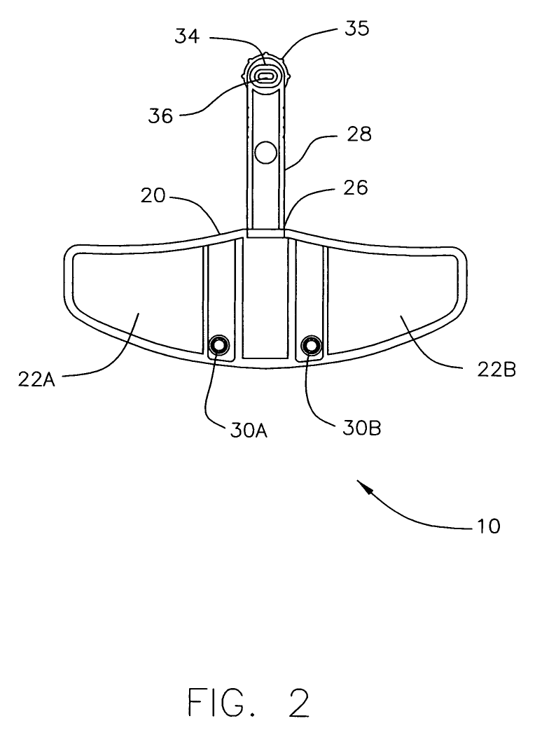

In one embodiment of the present invention, as illustrated in FIG. 2, a pair of guide pins 30a and 30b are located on the underside of base portion 20 with one disposed on either side of central track opening 26. First and second guide pins 30a and 30b are disposed towards the rear of base 20, in direction opposite central opening 42 of template 14.

A swivel handle 32 is disposed on the top of base 20 above central opening 26 and is configured to be gripped by a user during operation. Swivel handle 32 is capable of full 360 degree rotation such that a user does not need to adjust the positioning of their grip as they move cutter 10 around template 14. This allows for smoother movement of cutter 10 and thus a better circular cut of substrate 16.

In one embodiment of the present invention, as illustrated in FIGS. 1 through 3, adjustable member 28 further maintains a blade unit 34 disposed on the end facing central opening 42 of template 14 and extends downwardly towards substrate 16. Blade unit 34 maintains a swivel blade 36 configured to cut substrate 16 as cutter 10 is moved around template 14. The depth of swivel blade 36 may be adjusted up or down by adjustment means 35 located on blade unit 34 so that when cutter 10 is set upon template 14, swivel blade 36 will contact substrate 16 to the exact depth desired so as not to inhibit the proper cutting.

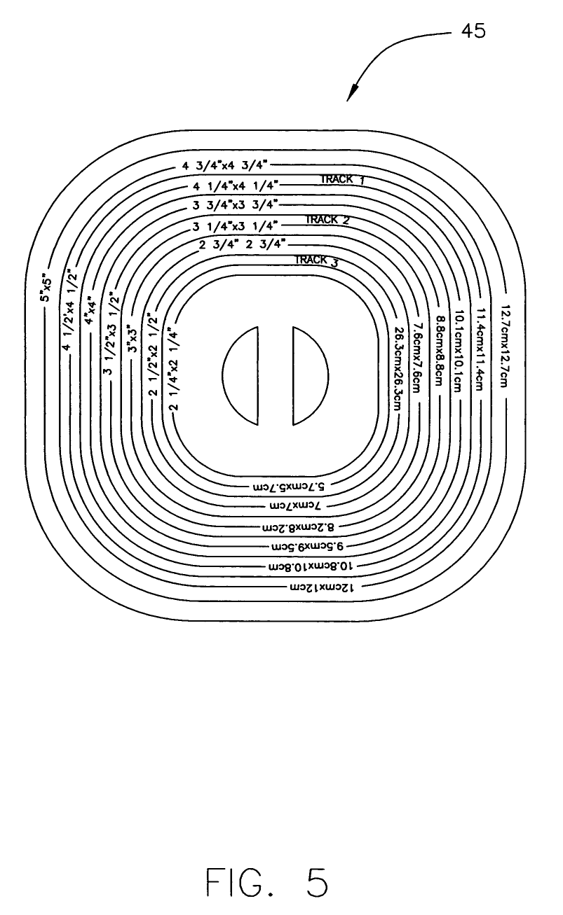

In one embodiment of the present invention, as illustrated in FIG. 1, template 14, is preferably circular in shape however, this is in no way intended to limit the scope of the present invention. For example, as illustrated in FIG. 5, template 14 may be circular, ovular or any other pattern that is capable of operating with cutter 10 described above.

Template 14 maintains upper and lower surfaces 40a and 40b. Lower surface 40b is configured to be placed on substrate 16 and may be fitted with a non-slip surface such textured plastic or firm rubber. Upper surface 40a of template 14 is configured to receive cutter 10. Template 16 further maintains a central opening 42 where blade unit 34 of cutter 10 acts on substrate 16 to cut the desired circular pattern.

Upper surface 40a of template 14 further maintains a series of tracking grooves. As illustrated in FIG. 4, guide tracking grooves 44a-44c are located adjacent to the inner central opening 42 and configured to receive first and second guide pins 30a and 30b from the underside of base portion 20 of cutter 10.

As illustrated in FIG. 4, guide tracking grooves 44a-44c maintain a decorative, substantially circular pattern. Thus, the shape to be cut into substrate 16 corresponds substantially to the shape of grooves 44. The depth and/or size of the cut into substrate 16 is set by setting adjustable member 28 at a particular depth within opening 26, as fixed by ball bearing 29 once it is locked into an opening 27 as described above.

In one embodiment of the present invention, as illustrated in FIG. 5, a depth measurement insert 45 is configured to be insertable within central opening 42 of template 14. While inside central opening 42, measurement insert 45 allows a user to place cutter 10 in one of tracks 44, adjust member 28 and check the depth within central opening 42 that blade 36 will cut out of substrate 16.

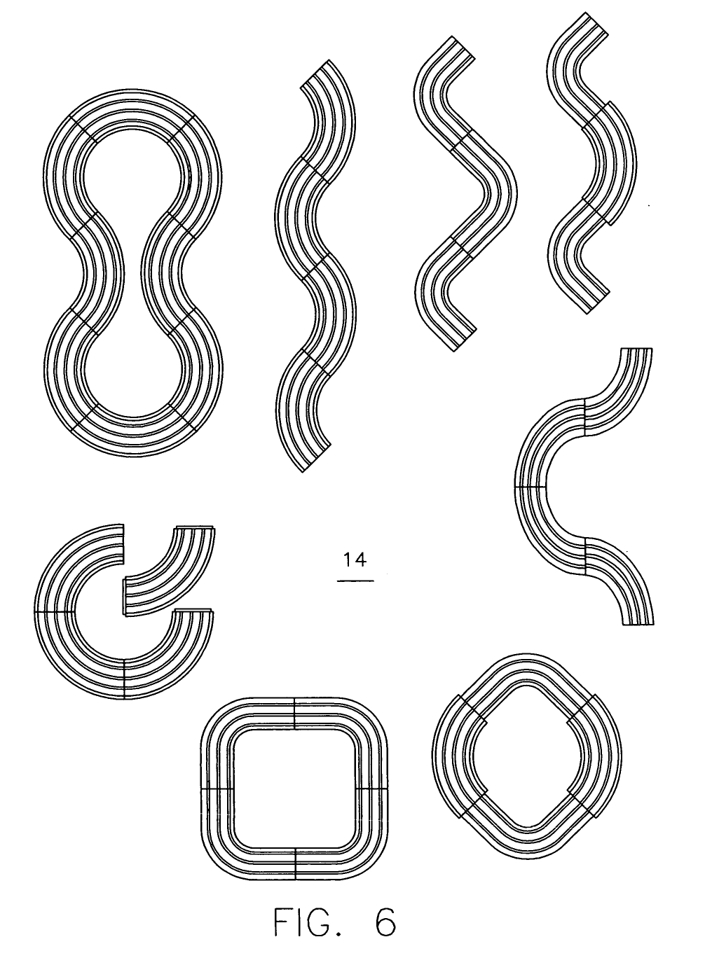

It should be noted that the above example of template 14 is intended only as one example of a template 14 to be used in cutting device 10 and is in no way intended to limit the scope of the present invention. For example, as illustrated in FIG. 6 differing patterns for template 14 may be used provided they are similarly constructed with grooves 44.

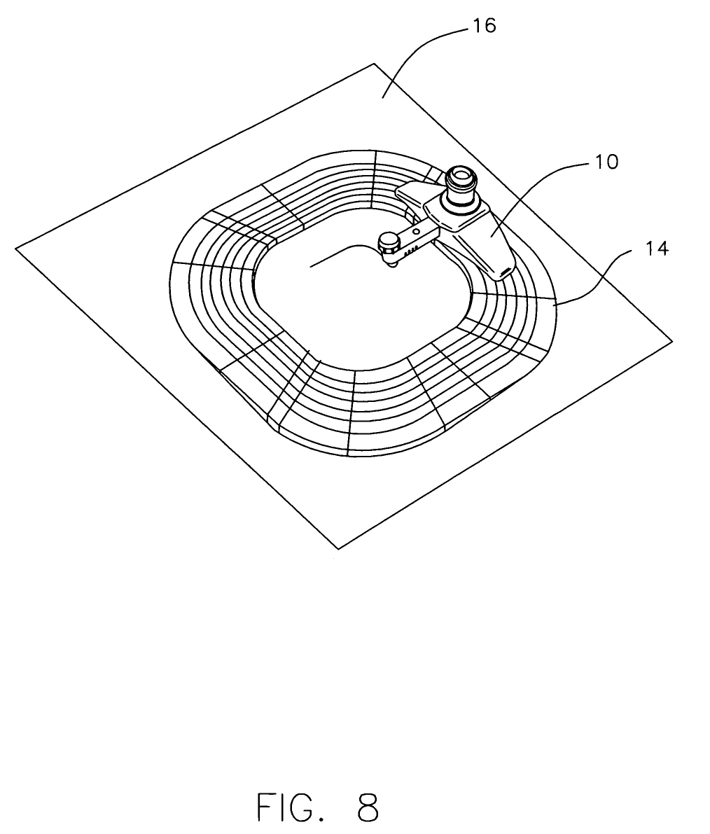

In one embodiment of the present invention, as illustrated in FIG. 7, substrate 16 is selected for having a circular pattern cut therein, whereby under side 40b of template 14 is placed on substrate 16. As illustrated in FIG. 8, cutter 10 is then placed onto template 14 such that first and second guide pins 30a and 30b are placed into a guide tracking groove 44. At the same time, adjustable member 28 is positioned relative to base portion 20 in central track region 26 so that blade 36 is positioned at the desired depth.

A user then firmly grips cutter 10, placing downward pressure on pressure points 24a and 24b of wing shaped handles 22a and 22b respectively. This pressure not only keeps cutter 10 stable and in contact with upper surface 40a of template 14, but it also helps keep lower surface 40b of template 14 in stable contact with substrate 16 so as not to allow movement relative to one another.

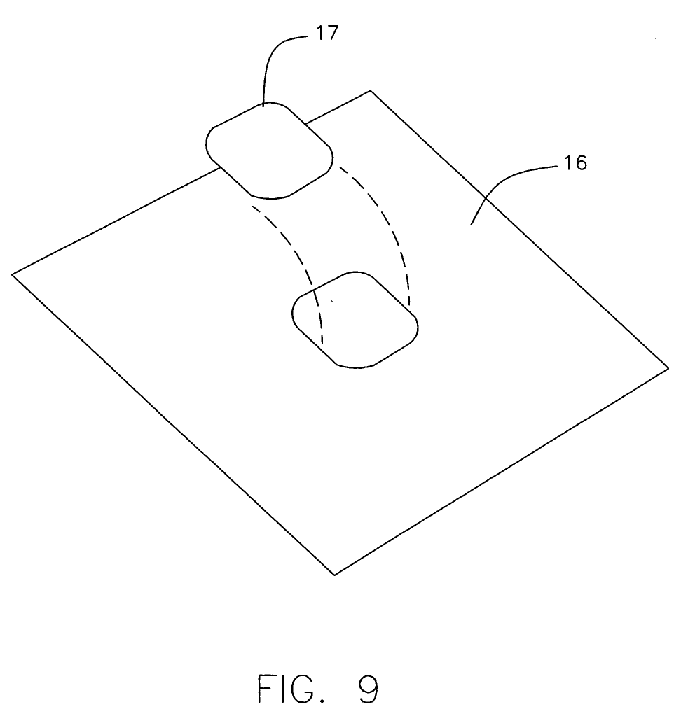

With the other hand, the user grips swivel handle 32 of adjustable member 28, and slowly moves cutter 10 around template 14 as shown in FIG. 8, such that blade unit 34 cuts the desired pattern into substrate 16. Guide pins 30a and 30b, disposed in guide tracking groove 44 ensure the smooth steady movement of cutter 10 around template 14. This is continued until cutter 10 makes a complete revolution around template 14, fully cutting a patterned cutout 17 from substrate 16 as shown in FIG. 9. It is understood that the operation may be conducted with one hand as well solely by gripping swivel handle 32 is so desired.

Thus, from the above described cutter 10 and template 14, it can been seen that the present invention provides a number of advantages over prior art cutter. First, the swivel handle allows cutter 10 to be moved continuously around template 14 without having to re-grip. This allows for a more smooth an accurate cutting motion, avoiding unwanted burs or other cut line disfigurements that may occur in the substrate with stop and start cutting motions.

Secondly, pressure points 24a and 24b of wing shaped handles 22a and 22b respectively, allow for user to place further stabilizing force on cutter 10 during the cutting motion to avoid cutter 10 from being dislodged from tracking grooves 44.

Third, by allowing adjustable arm 28 to be easily moved to various depths within central opening 42 of template 14 by simply locking with the ball bearing 29/opening 27 combinations within cutter opening 26, a simple cost effective design allows rapid change of depths, while simultaneously allowing for sufficient securing of depth during the cutting motions.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

1. A cutter for cutting a pattern in a substrate, said cutter comprising:
a base;
guide pins disposed on the bottom of the base, said guide pins configured to be placed in a groove on a template; and
a longitudinally adjustable member configured to support a blade unit for cutting said pattern into said substrate, wherein said adjustable member is configured to be slidably positioned within a center track opening region movable towards and away from said guide pins.

2. The cutter as claimed in claim 1, wherein said adjustable member further comprises a spring biased member located on its upper surface, said spring biased member being configured to lock within a corresponding openings within said center track opening region of said base.

3. The cutter as claimed in claim 2, wherein said center track opening region of said base maintains a plurality of corresponding openings configured to accept said spring biased member.

4. The cutter as claimed in claim 1, wherein said spring biased member is a ball bearing.

5. The cutter as claimed in claim 1, wherein said blade unit further comprises an adjustment means so as to adjust its height of a blade against said substrate.

6. The cutter as claimed in claim 1, wherein said blade unit of said adjustable member is configured to fall within a central opening of said template.

7. The cutter as claimed in claim 4, wherein said template further comprises a depth insert, said depth insert configured to fit within said central opening, allowing a user to measure the depth of said blade unit on said substrate.

8. A cutter for cutting a pattern in a substrate, said cutter comprising:
a base, configured to be placed on a template; and
an adjustable member, wherein said base is provided with first and second wing shaped handles, extending from said base, substantially perpendicular to said adjustable member, configured to rest on top of said template, such that when said template is placed on a substrate and said cutting tool is placed on said template, pressure can be applied to said wing shaped handles so as to allow said cutting tool to be moved around said template, cutting the desired pattern into said substrate.

9. The cutter as claimed in claim 8, wherein said wing shaped handles further comprise pressure points, located distal to said base, configured to provide a gripping area so as to apply downward pressure to said cutter against said template.

10. The cutter as claimed in claim 8, wherein said base further comprises a pair of guide pins configured to be positioned within a guide tracking groove on said template.

11. The cutter as claimed in claim 10, wherein said adjustable member is slidably positioned within a central track region of said base, movable towards and away from said guide pins, so as to allow a user to adjust the depth blade within a central opening of said template.

12. The cutter as claimed in claim 8, wherein said adjustable member further comprises a spring biased member located on its upper surface, said spring biased member being configured to lock within a corresponding openings within said center track opening region of said base.

13. The cutter as claimed in claim 12, wherein said center track opening region of said base maintains a plurality of corresponding openings configured to accept said spring biased member.

14. The cutter as claimed in claim 8, wherein said spring biased member is a ball bearing.

15. The cutter as claimed in claim 8, wherein said base further comprises a swivel handle.

16. The cutter as claimed in claim 8, wherein said blade unit further comprises an adjustment means so as to adjust its height of a blade against said substrate.
